(19) United States
(12) Patent Application Publication
(10) Pub. No.: US 2007/0204156 A1
(43) Pub. Date: Aug. 30, 2007

(54) Systems and methods for providing access to network resources based upon temporary keys

(76) Inventor: Mark Jeghers, San Jose, CA (US)

Correspondence Address: INGRASSIA FISHER & LORENZ, P.C., 7150 E. CAMELBACK, STE. 325, SCOTTSDALE, AZ, 85251, US

(21) Appl. No.: 11/364,892

(22) Filed: Feb. 28, 2006

(51) Int. Cl. H04L 9/00

(52) U.S. Cl. 713/168

(57) ABSTRACT

Secure access to a wireless switch or other server node is provided through the use of a temporary key. The server initially receives a key request from a remotely-located client application that is formatted according to a first protocol such as the simple network management protocol (SNMP). In response to the key request, the server generates a temporary key that is provided to the client application and also stored at the server. After receiving the temporary key, the client application creates a service request that includes the temporary key. Examples of suitable protocols for the server request include the common gateway interface (CGI) and active server pages (ASP) formats. After receiving the service request, the server provides access to the network service if the temporary key in the service request matches the temporary key stored in the database, and otherwise does not provide access to the network service

### TECHNICAL FIELD

The present invention relates generally to network security, and more particularly, to techniques for providing access to a networked resource based upon a temporary key.

### BACKGROUND

In recent years, there has been a dramatic increase in demand for networked computing systems. With the expansion of the Internet and World Wide Web, for example, the functionality and ubiquity of network services continues to expand at a very rapid pace. Frequently, networked services are provided in accordance with the well-known “client-server” computing model, in which a “server” node on a network provides data or processing services to one or more “client” nodes operating on the same network. Generally speaking, client-server architectures can be used to provide any number of networked services, including remote login, file transfer, messaging, web hosting and the like.

Numerous computing protocols have been developed that allow for communications between clients and servers connected via a digital network. Conventional web pages, for example, are typically viewed as documents formatted in accordance with a well-known hypertext markup language (HTML) that is appropriately formatted and displayed by a conventional browser application. More recently, other client-server mechanisms such as active server pages (ASP), common gateway interface (CGI) and the like allow clients to provide information (e.g. as part of a uniform resource locator (URL)) back to the server. This two-way communications channel allows for more sophisticated interactions to take place between clients and servers than were previously available.

One disadvantage of conventional ASP, CGI and other web services, however, is that such features are typically available to any client application that is aware of the service. That is, it is difficult to limit the usage of ASP or CGI features to authorized users without also granting access to other unauthorized users, many of whom may have illegitimate or malicious intent. In the case of a wireless switch, for example, it may be desirable to allow approved clients to gain access to switch features (e.g. configuration utilities and the like) using ASP, CGI and/or the like without allowing unauthorized users to have access to the same features.

Accordingly, it is desirable to provide a security scheme that allows authorized clients ready access to server capabilities while preventing unauthorized clients from gaining access to the same services. Other desirable features and characteristics will become apparent from the subsequent detailed description and the appended claims, taken in conjunction with the accompanying drawings and the foregoing technical field and background.

### BRIEF SUMMARY

According to various exemplary embodiments, access to a network resource provided by a wireless switch or other server node is provided in a secure manner. The server initially receives a key request from a remotely-located client application that is formatted according to a first protocol such as the simple network management protocol (SNMP). In response to the key request, the server generates a temporary key that is provided to the client application and also stored at the server. After receiving the temporary key, the client application creates a service request that includes the temporary key. An example of a suitable protocol for the server request includes the common gateway interface (CGI). After receiving the service request, the server provides access to the network service if the temporary key in the service request matches the temporary key stored in the database, and otherwise does not provide access to the network service.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a block diagram of an exemplary network server system; and

FIG. 2 is a process flow diagram showing an exemplary technique for obtaining secure access to a network resource provided by a server.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description.

According to various embodiments, unsecure protocols such as common gateway interface (CGI), active server pages (ASP) and/or the like are made more secure through the use of temporary keys. Generally speaking, authorized client applications are created to request a key from the server prior to requesting the network service. This key is returned from the server and included in the client's subsequent request for services. By requiring a client to present the temporary key before granting access to the service, the server can be relatively confident that the client was legitimately created, and that access to the network service is therefore appropriate.

Various aspects of the exemplary embodiments may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., radio-frequency (RF) devices, memory elements, digital signal processing elements, logic elements and/or the like, which may carry out a variety of functions under the control of one or more microprocessors or other control devices. In addition, the present invention may be practiced in conjunction with any number of data transmission protocols and that the system described herein is merely one exemplary application for the invention.

For the sake of brevity, conventional techniques related to signal processing, data transmission, signaling, network control, the IEEE 802.11 family of specifications, and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

Without loss of generality, many of the functions usually provided by a traditional wireless access point (e.g., network management, wireless configuration, and the like) can be concentrated in a corresponding wireless switch. It will be appreciated that the present invention is not so limited, and that the methods and systems described herein may be used in the context of other network environments, including any architecture that makes use of client-server principles or structures.

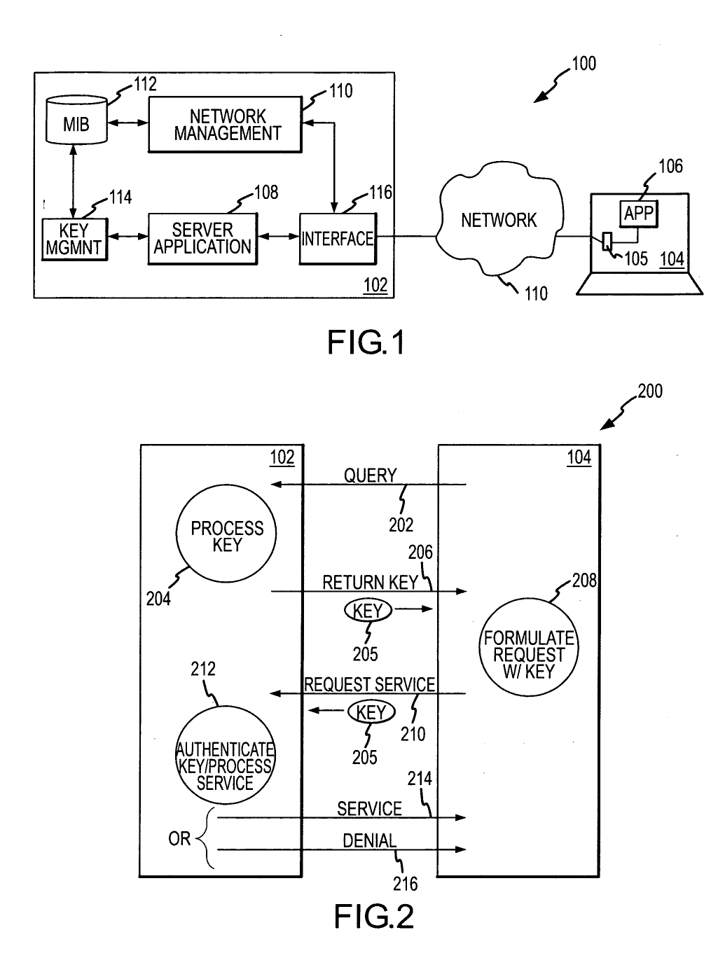

Turning now to the drawing figures and with initial reference to FIG. 1, an exemplary network server arrangement 100 suitably includes a server node 102 that communicates with a client node 104 via network 110. Network 110 is any local area, metropolitan area and/or wide area network, or any combination of public and/or private networks capable of supporting digital communication between the two nodes.

In a typical embodiment, client 104 is any conventional computing terminal or device that includes an interface 105 to network 110. Client node 104 typically executes one or more client applications 106 that communicate with server 102, as described more fully below. Client application 106 is any application, module, applet, program or other computing logic capable of interacting with server node 102 and/or network 110. In various embodiments, client application 106 is a JAVA applet or the like that is obtained from server 102 using conventional file transfer mechanisms. Alternatively, client application 106 may be obtained from any public or private source as appropriate.

Server 102 is any node coupled to network 110 that is capable of providing a network service. In various embodiments, server 102 may be implemented with any sort of computing hardware and/or software. Server 102 may be a conventional computer host, for example, or may be implemented as a feature in any other computing device. In various embodiments, for example, server 102 is a wireless switch such as any of the various products available from the Symbol Corporation of San Jose, Calif.

Server 102 suitably includes a server application 108 that provides the network service, a network management module 110 that supports queries to a database 112, and a key management module 114, as well as a conventional interface 116 to network 110. In various embodiments, network interface 116 includes any sort of network interface card (NIC) as well as any type of protocol stack or the like to facilitate communications on network 110.

Server application 108 is any program, script, application or collection of computing modules capable of providing a network service to client application 106. In various embodiments, server application 108 provides conventional web server functions such as transmitting electronic files formatted in HTML, XML or other formats to client browser applications. Additionally or alternatively, server application 108 is able to process information queries or other service requests from client applications 106 via network interface 116. Server application 108 may interpret data provided by a client application 106, for example, in accordance with the application server pages (ASP), common gateway interface (CGI) or any other protocol. In the CGI scenario, for example, client application 106 formats queries or other service requests as data contained within a conventional uniform resource locator (URL) that is passed to server 102 and interpreted by application 108 to perform a requested service. In various embodiments, key information contained within such a URL can be extracted and used to verify that the client application 106 is authorized to obtain the requested service, as described more fully below.

Network management module 110 is any program, process, logic or other module capable of receiving key requests from client 102, of positing a query to database 112 in response to the key request, and providing an appropriate response to client application 106 via network interface 116. In various embodiments, network management application 110 is a conventional implementation of the simple network management protocol (SNMP), such as the SNMP V3 protocols defined in various Internet RFCs (including RFCs 1155, 1156, 1157, 3413 and 3584, as well as others). Network management module 110 may receive a conventional SNMP “get” command from client application 106, for example, that can result in a query to database 112 and a conventional SNMP response.

Database 112 is any repository, data store, data structure or other construct capable of retaining temporary key information. In various embodiments, database 112 is implemented as a management information base (MIB) in accordance with Internet RFC 1156 or the like. Alternatively, database 112 may be implemented as a simple data store located in memory, as a file stored in mass storage or the like.

Key management module 114 is any script, application, logic or other module executing on server 102 that is capable of generating temporary keys. The key may be as simple as a random sequence of bits, or may constitute a digital signature or other credential. Typically, it is desirable for the key to be as long as practicable to decrease the probability of randomly guessing the value of the key. Keys may be random strings of sixteen, thirty-two, sixty-four or more bits, for example. Further, the key is intended as a temporary key in that has relatively short useful life, typically on the order of several (e.g. five or ten) seconds or so. In the event that a malicious party does obtain a copy of the key, then, the temporary key will expire before any significant damage can be done with such information. Keys may be created in response to queries received at network management module 110. In various equivalent embodiments, keys are generated on a relatively continuous basis, with newer keys continually replacing the prior keys as appropriate.

In operation, then, client application 106 initially requests a copy of the temporary key by transmitting a key request message in SNMP or another appropriate format to network management module 110. Server node 102 suitably receives the key request via network 110 at interface 116, which appropriately forwards the query to network management module 110 for handling. Key management module 114 then creates a temporary key of an appropriate length and stores the key in database 112. Network management module 110 subsequently retrieves the key from database 112 and forwards the key to client application 106 using conventional SNMP or similar structures.

After receiving the temporary key, client application 106 appropriately uses the key to gain access to a network service provided by server 102. Client application 106 formats and transmits an appropriate service request message on network 110 to server 102, which receives the message at interface 116. Server 102 then forwards the service request message to server application 108, which appropriately extracts the temporary key from the message and compares the received key to the key previously generated by key management module 114. If the keys match, access can be granted to the network service using conventional techniques. Because rogue applications will rarely include the key request feature and server application 108 requires presentation of the temporary key prior to granting access to the network service, the temporary key greatly enhances the security of the network service. Additional security may be provided by requiring a userid/password combination, digital signature, biometric or other credential prior to gaining access to the service and/or prior to downloading client application 106 from server 102 (in embodiments where such functionality is provided). Even more security can be provided by encrypting communications between client 104 and server 102. Conventional secure hypertext transport protocol (HTTPS), for example, provides such functionality. For even more security, key management module 114 can be restricted to run only in a shell executed by server 102; that is, remote access to key management module 114 can be disabled to prevent tampering that could compromise server 102.

Various further modifications may be made to the exemplary embodiment shown in FIG. 1. In particular, the functionality of the key management module 114 may be incorporated into server application 108 and/or network management module 110 without departing from the concepts of the invention. The various modules and components shown in FIG. 1 may therefore be combined, omitted or modified in numerous ways to arrive at any number of alternate but equivalent embodiments.

With reference now to FIG. 2, an exemplary process 200 for establishing access to a network service executing on server 102 from a client 104 suitably includes the broad steps of obtaining the temporary key 205, formulating a service request with the temporary key (step 208), and verifying the key contained within the service request prior to granting access to the network resource.

As noted above, client 104 suitably requests a temporary key 205 by formatting a message 202 in an appropriate format that can be processed at server 102, such as SNMP. Key request message 202 may therefore be implemented with a conventional SNMP “get” query, for example. Server 102 receives query 202 and appropriately processes a temporary key 205 for client 104 (step 204). In various embodiments, server 102 generates key 205 in response to query 202; alternatively, keys can be generated on a relatively continuous basis, with subsequent keys replacing keys that were previously generated. As noted above, keys may be produced with any random, pseudo-random or other process that results in a stream of bits that are unlikely to be guessed by a malicious user. Keys may be further obscured by assigning entries in database 112 (FIG. 1) relatively innocuous names, by placing key bits in non-contiguous order, by blending the key bits with other data requested by client 104, and/or other techniques as appropriate. The generated key 205 is then passed to client 102 as part of a key return message 206, which may be provided using conventional SNMP constructs. In various embodiments, the key is encrypted and/or obscured during transmission to prevent malicious network listeners from discovering the temporary key.

Upon receipt of the key return message 206, client 104 extracts the temporary key 205 and formulates a suitably request for network services 210 that includes key 205. Service request 210 may be created in any suitable format, such as CGI, ASP and/or the like. Service request 210 is then transmitted to server 102 via network 110.

Server 102 receives service request 210, authenticates the key 205 contained within the request, and approves or rejects the service request as appropriate. As noted above, key 205 contained within service request 210 is compared with the previously-generated key to ensure that a match exists. This authentication can take place within server application 108, or can be performed by passing the received key 205 to key management module 114, which executes within an operating system shell of server 102. If a match is found, the connection is approved (as indicated in message 214); conversely, if no match is found, the connection is not approved, as indicated by message 216.

Keys generated within this system may be handled in any manner. In various embodiments, keys are considered as “expired” or no longer valid after the key has been used by a client 104 and/or after an appropriate period of time has elapsed. If a key is no longer valid, client 104 may be prompted to re-request a new key, or the service may simply be denied. In the event that the service is not authenticated on the first attempt, various client applications 106 may be configured to re-try (with or without first obtaining a new key), or to otherwise exit the connection attempt gracefully.

By requiring applications 106 to provide a temporary key prior to gaining access, certain protocols such as CGI, ASP and/or the like can be made significantly more secure and robust. The key can be designed to be difficult to identify and intercept, and can be further protected through the temporary nature of the keys themselves. Further, by providing access to keys using conventional network structures (e.g. SNMP), the task of obtaining the key is relatively straightforward for legitimate developers.

The particular aspects and features described herein may be implemented in any manner. In various embodiments, the processes described above are implemented in software that executes within one or more wireless switches. This software may be in source or object code form, and may reside in any medium or media, including random access, read only, flash or other memory, as well as any magnetic, optical or other storage media. In other embodiments, the features described herein may be implemented in hardware, firmware and/or any other suitable logic.

It should be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A method of granting secure access from a client to a networked resource on a server, the method comprising the steps of:
receiving a request from the client at the server;
in response to the request, generating a temporary key;
providing the temporary key to the client;
receiving a subsequent request from the client at the server, wherein the request comprises the temporary key; and
providing access to the networked resource on the server if the temporary key contained within the subsequent request matches the temporary key previously generated, and otherwise not providing access to the networked resource.

2. The method of claim 1 wherein the request and the subsequent request are formatted according to different protocols.

3. The method of claim 1 wherein the request is a simple network management protocol (SNMP) request.

4. The method of claim 3 wherein the temporary key is stored as a management information base (MIB) variable.

5. The method of claim 4 wherein the subsequent request is a common gateway interface (CGI) request.

6. The method of claim 1 wherein the subsequent request is a common gateway interface (CGI) request.

7. The method of claim 1 wherein the subsequent request is an active server page (ASP) request.

8. The method of claim 1 wherein the networked resource is a wireless switch.

9. The method of claim 1 further comprising the step of providing a client application from the server to the client, and wherein the client application is configured to generate the request and the subsequent request.

10. The method of claim 1 further comprising the steps of obtaining a userid and password from the client, and verifying the userid and password prior to granting access to the networked resource.

11. A method of providing access a network service provided by a wireless switch, the method comprising the steps of:
receiving a key request from a remotely-located client application formatted according to a first protocol;
in response to the key request, generating a temporary key and storing a copy of the key in a database on the wireless switch;
providing the temporary key to the client application;
receiving a service request from the client application that is formatted according to a second protocol different from the first protocol, wherein the service request comprises the temporary key; and
providing access to the network service if the temporary key contained within the service request matches the temporary key previously generated, and otherwise not providing access to the network resource.

12. The method of claim 11 wherein the first protocol is simple network management protocol (SNMP).

13. The method of claim 11 wherein the second protocol is active server pages (ASP).

14. The method of claim 11 wherein the second protocol is common gateway interface (CGI).

15. A network server system configured to provide a network service on a digital network, the network server system comprising:
an interface to the digital network;
a database configured to store a temporary key;
a management module configured to receive key requests from a client application via the interface, to retrieve the temporary key from the database, and to return the temporary key to the client application; and
a server application configured to provide the network service via the interface, wherein the server application is further configured to receive a service request from the client application that includes the temporary key, to provide the network service if the temporary key received in the client application matches the temporary key previously returned to the client application, and to otherwise not provide the network service.

16. The network server system of claim 15 further comprising a key management module in communication with the server application, wherein the key management module is configured to generate the temporary key, to store the temporary key in the database, and verify the temporary key for the server application.

17. The network server system of claim 15 wherein the key request is formatted as simple network management protocol (SNMP) requests.

18. The network server system of claim 15 wherein the service request is formatted as an active server page (ASP) request.

19. The network server system of claim 15 wherein the service request is formatted as a common gateway interface (CGI) request.

20. The network server system of claim 15 wherein the network server is a wireless switch.
